(19) United States
(12) Patent Application Publication
(10) Pub. No.: US 2019/0269569 A1
(43) Pub. Date: Sep. 5, 2019

(54) PATIENT SUPPORT SURFACE MODULE WITH LOCKING DEVICE

(71) Applicant: MAQUET GMBH, Rastatt (DE)

(72) Inventor: Bernhard KATZENSTEIN, Iffezheim (DE)

(73) Assignee: MAQUET GMBH, Rastatt (DE)

(21) Appl. No.: 16/418,834

(22) Filed: May 21, 2019

Related U.S. Application Data
(63) Continuation of application No. PCT/EP2017/080090, filed on Nov. 22, 2017.

(30) Foreign Application Priority Data
Nov. 28, 2016 (DE) 10 2016 122 938.5

(51) Int. Cl. A61G 13/12

(52) U.S. Cl. CPC A61G 13/1285; A61G 2200/32; A61G 2203/78

(57) ABSTRACT

A patient support surface module for supporting a patient body parthas a locking device with a plug bolt for engaging a receiving opening in a patient table or the like. A bolt element is movably accommodated in a through opening in the plug bolt, and a longitudinal axis of the through opening extends at an acute angle relative to a longitudinal axis of the plug bolt. The bolt element can engage a receiving opening for securing the plug bolt in the receiving opening. An actuating element is operably connected to the bolt element for moving the bolt element and the locking device between locked and released positions.

### RELATED FILINGS

Benefit and priority is claimed with respect to German patent application DE 10 2016 122 938.5 (filed Nov. 28, 2016), and international application PCT/EP2017/080090 (filed Nov. 22, 2017). Both are incorporated herein.

### BACKGROUND OF THE DISCLOSURE

The present disclosure relates to a patient support surface module having a locking device for a plug pin interface that is used for connecting the patient support surface module to an operating table.

Various types of coupling mechanisms are known for detachably connecting two bodies to one another.

US 2006/0201289 A1 describes a quick release mechanism for releasing a holder, which can accommodate insertion tools, from a wrench. This coupling mechanism is specifically designed for hand tools, and intended for transmitting torques. Therefore, it is totally unsuitable for use in surgery.

For some interface geometries, such as interfaces with a hook-shaped or dovetailed design, the longitudinal axes of the modules must be adjusted at an angle relative to one another or moved vertically in parallel. In such cases, the patient situated on the possible support device must be additionally lifted or unergonomically positioned during an exchange of modules.

In known cylindrical bolt interfaces, a preferably cylindrical receiving hole with a groove introduced into its lateral surface is provided on a first module. A corresponding cylindrical bolt is provided on a second module. At least one body, which may be brought into two positions relative to the lateral surface of the bolt, is supported in this bolt-shaped element. In a first position of the body, a portion of the body protrudes beyond the lateral surface, so that the body comes to rest in the groove of the receiving hole. In a second position, the body is outside the groove and is inside the enveloping lateral surface of the bolt-shaped element.

The interface elements may be put together or taken apart when the body is in a second position. This is no longer possible when the body is in the first position, since the body prevents a relative movement of the interface elements relative to one another in a form-fit and therefore effective manner.

If the interface is now acted on by forces, along the direction of its insertion axis, which tend to separate the interface elements, these forces act, via the grooved wall, on the bolt body and into the wall of the bolt element that accommodates the bolt body, and on the surface of the actuating element, which can bring the bolt body into a first and a second position.

In known interfaces, for example a ball is used as the body. In this case the forces must not be selected to be too high, since otherwise, the surface pressures in the area of the contact surfaces may exceed the maximum allowable surface pressures of the materials of which the interface elements are made, possibly resulting in local deformation of the surfaces of the components or even bending of the components. Accordingly, bolt elements that are ball-shaped due to the design are disadvantageous in the event that high axial forces occur.

Another problem arises when the orientation of the coupled modules in space can change, and, for example, the surface of a patient support surface is adjusted at an angle relative to the floor. The forces generated on the interfaces by this angular adjustment may be distributed in components transverse to the longitudinal axis and parallel to the longitudinal axis of the interface axis. As a result, the modules along the interface axis may be undesirably decoupled from the base support surface if the locking mechanism of the interface is accidentally actuated. This in turn may result in severe injury to the patient on the support surface, and also to the operator.

### OVERVIEW OF THE DISCLOSURE

The object of the present disclosure is to provide a patient support surface module having a secure, easily detachable, and mechanically robust locking device for a plug pin interface. In some embodiments the male interface fits existing patient support devices.

Operating tables, couches, and beds for supporting persons may have a modular design, in which they are made up of various modules that can be connected to one another. Manually operable mechanical interfaces are usually used for this purpose, since they can be operated by hand without supplying additional energy.

Support devices can have at least two rod-shaped side rails oriented approximately in parallel. Plates that are supported on or at the rods may be mounted in the area between these side rails. In turn, padding on which the person to be treated is preferably supported is frequently mounted on these plates.

Side rails are frequently constructed with articulated joints so that the support device may be angularly adapted to a setting that is preferred for treating the person. A plurality of articulated joints can be provided to allow optimal adjustment for persons of different sizes.

Thus, in order for such a patient support surface to have a modular design, the respective side rails of the individual elements can be detachably connectable to one another to allow coupling of modules of different lengths or modules with special adjustment functions. Therefore, the corresponding interfaces and their control devices can be designed to be as small as possible so that the space for articulated joints is not unnecessarily limited.

Preferably the operating forces for actuating the coupling elements are only great enough so that actuation can be comfortably carried out using only one or more fingers, without additional aids. On the other hand, the fixing preferably takes place with as little play as possible so that there is little relative movement between the coupled elements.

Another aspect to be considered when putting together and locking the modules of a patient support surface concerns the relative movement, during the coupling operation, of the elements to be coupled. Preferably the axial orientation of the components relative to one another remains the same during the entire operation. This allows coupling and uncoupling of modules, even when a patient is situated on the possible support device.

Useful plug bolts of the locking device according to the disclosure are thus particularly robust, since they are preferably weakened solely by a single through hole that extends at an acute angle relative to the longitudinal axis of the plug bolt, and it is not necessary to provide additional boreholes in the plug pin.

Furthermore, the bolt element that is accommodated in the through opening can preferably be actuated and controlled from one end of the plug bolt, so that in a locked position it protrudes beyond the lateral surface of the plug bolt, and in a released position it is accommodated within the lateral surface of the plug bolt.

According to several embodiments, the bolt element may be linearly displaceably situated in the through opening. The bolt element may thus be displaceable, for example, along the longitudinal direction of the through opening. For example, along a longitudinal axis of the through opening which is at an acute angle with respect to a longitudinal axis of the plug bolt, and also at an acute angle with respect to female receiving openings for use with the male plug bolt. Female receiving openings may include a locking recess shaped and positioned for receiving the bolt element, optionally at the same acute angle.

The bolt element may then include a toothed rack, and the actuating element may include a gearwheel or a gearwheel segment in order to bring about a displacement of the bolt element via rotation of the actuating element. Alternatively, the gearwheel or gearwheel segment may be provided on the bolt element and the toothed rack may be provided on the actuating element, or some other mechanical coupling, for example with a coupling piece, may be provided by means of which swiveling of an actuating element, for example an actuating lever, may be converted into a displacement of the bolt element. According to further embodiments, the actuating element may also include a hook, an eye, or a release lever by means of which the bolt element may be moved in the through opening.

According to several embodiments, the bolt element may be rotatably situated in the through opening. The entire bolt element or individual sections of the bolt element may thus be rotated by the actuating element, directly or with the aid of a suitable mechanical coupling, about the longitudinal axis of the through opening.

According to several embodiments, the bolt element may be longitudinally displaceably and rotatably situated in the through opening. The bolt element or individual sections of the bolt element may thus be moved and rotated, sequentially or also in combination, by the actuating element or by the configuration of the through opening.

The actuating element may include a finger lever or thumb lever having a recessed grip for a finger or thumb of a user to allow simple operation of the actuating element.

The plug pin element accommodating the actuating element, or the locking device, may in each case include at least one deflector rib that prevents a user from being caught on the actuating element. Due to the deflector rib, a finger or also an item of clothing of the user slides off the actuating element upon accidental contact, and targeted gripping of the actuating element is necessary to guide a finger or thumb of the user past the deflector rib and reach the recessed grip.

According to several embodiments, the actuating element may have a release button, so that the actuating element is movable only when the release button is simultaneously actuated. Incorrect actuation of the locking device by accident is thus effectively prevented.

According to further embodiments, the actuating element may be movable from a first position, in which a movement of the bolt element is blocked, into a second position, the actuating element being movable from the second position into a third position in order to move the bolt element from its locked position into its released position. Incorrect actuation of the locking device by accident is thus likewise prevented, since successful release of the locking device requires, for example, a linear displacement of the actuating element from the first position into the second position, followed by swiveling the actuating element from the second position into the third position.

The actuating element may include a locking tab which in the first position rests against a contact surface of the locking device, wherein the movement into the second position includes a displacement of the locking tab relative to the contact surface. Thus, in the first position the locking tab blocks, for example, a rotational movement of the actuating element, and only when the locking tab has been pushed past the contact surface can the actuating element be rotated into the third position.

In particular, it may be provided that the disclosed locking device is also usable with existing female modules by adapting the dimensions and shape of the plug pin and of the bolt element to the receiving openings of existing systems.

According to several embodiments, at least one wall surface of the locking recess may extend essentially parallel to a longitudinal axis of the through opening in the plug bolt, so that a side face of the bolt element in the locked position rests at least linearly or tangentially, but preferably flatly, against the wall surface. A contact surface that is greatly enlarged compared to conventional ball-shaped detent elements is thus provided, so that particularly secure locking is achieved, and surface pressures in the area of the bolt element cannot assume such high values that there would be concern for deformation of the components.

According to several embodiments, the angular orientation of the wall surface of the locking recess may assume a larger angle, relative to the orientation of the plug bolt, compared to the angle between the orientation of the receiving opening of the bolt element and the orientation of the plug bolt. As a result, in the event that the locked locking device is acted on by forces along the orientation of the plug bolt that might separate the locked objects, the forces act on the bolt element that force the bolt element into the locking recess of the plug bolt holder.

The embodiment of the contact surfaces of the locking recess may be made up of cylindrical, conical, spherical, semi-spherical, or dome-shaped surface form elements or combinations thereof.

### BRIEF DESCRIPTION OF THE DRAWINGS

Exemplary embodiments of the present disclosure are described below with reference to the appended drawings, in which identical or corresponding elements are denoted by the same reference numerals.

FIG. 1 shows a schematic illustration of a modular patient support surface in which a locking device according to several embodiments may be used;

FIG. 2 shows a cross section of a plug bolt interface in the locked state according to a first embodiment;

FIG. 3 shows a perspective view of the plug bolt from FIG. 2;

FIG. 4 shows a side view of the plug bolt from FIG. 2;

FIG. 5 shows a detailed view of a plug pin according to another embodiment of the locking device, in a released position;

FIG. 6 shows the plug pin according to FIG. 5 in a locked position/intermediate position;

FIG. 7 shows the locking device according to the first embodiment, in a locked position;

FIG. 8 shows the locking device from FIG. 7 in a released position;

FIG. 9 shows one embodiment of a coupling between an actuating element and a bolt element of a locking device;

FIG. 10 shows the coupling from FIG. 9 in a different view;

FIG. 11 shows a first position of an actuating element according to one embodiment;

FIG. 12 shows a second position of an actuating element according to one embodiment;

FIG. 13 shows a third position of an actuating element according to one embodiment;

FIG. 14 shows a detailed view of one possible design of the actuating element;

FIG. 15 shows another view of the actuating element from FIG. 14;

FIG. 16 shows another embodiment of an actuating element;

FIG. 17 shows a detail of the actuating element from FIG. 16;

FIG. 18 shows a sectional view of a plug bolt according to the prior art;

FIG. 19 shows a sectional view of a plug bolt according to one embodiment; and

FIG. 20 shows a plug bolt holder according to one embodiment.

### DETAILED DESCRIPTION

Exemplary embodiments of the present disclosure are explained in the following description, with reference to the drawings. The drawings are not necessarily true to scale, and are intended to merely schematically illustrate the particular features.

It is noted that the features and components described below may be combined with one another in each case, regardless of whether they have been described in conjunction with an individual embodiment. The combination of features in the particular embodiments is used solely to illustrate the basic design and the operating principle of the claimed device.

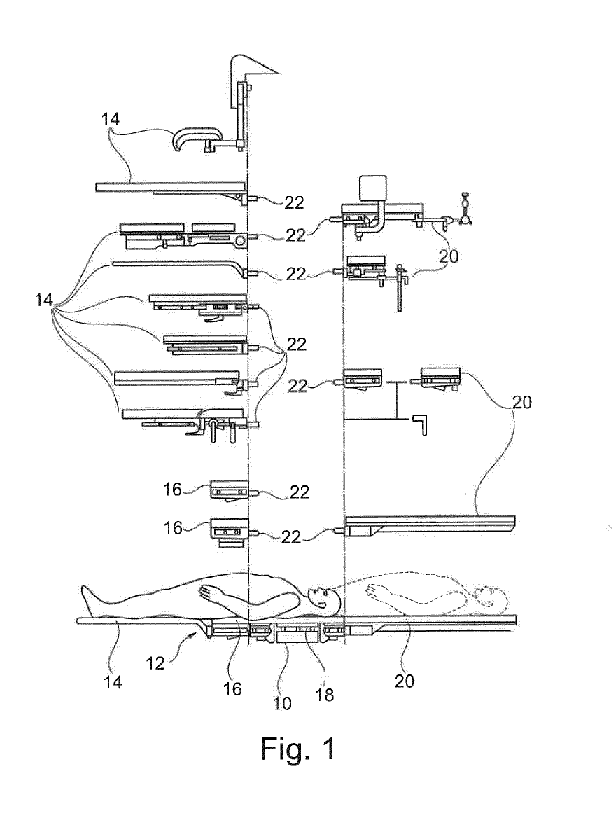

FIG. 1 shows a modular patient support surface 12 that is fastened to a torso support surface 10 of an operating table, not illustrated, and that has versatile uses during surgery. The patient support surface 12 has a number of exchangeable modules 14, 16, 18, 20 for supporting body parts of a patient, and which are removably fastened to one another to allow appropriate support of the patient for different types of surgery. Bolt interfaces 22 are provided in each case for fastening the modules 14-20 to one another, wherein a plug bolt of one module is inserted into a receiving opening of an adjacent module or the torso support surface 10, and locked.

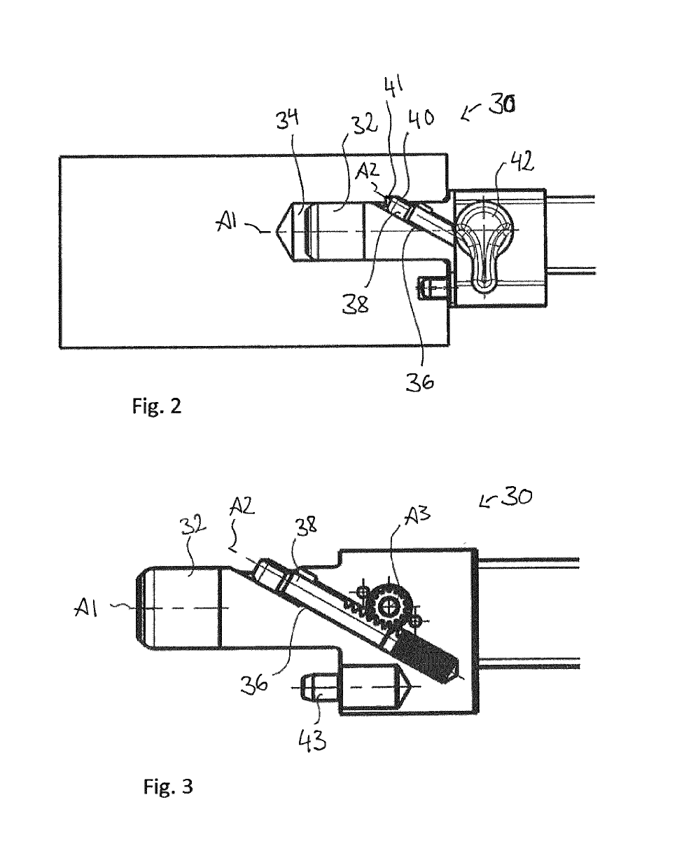

FIG. 2 shows one embodiment of a locking device 30 according to the disclosure, wherein a plug bolt 32 of a first module is accommodated in a receiving opening 34 of another module. A bolt element 38 is situated in a through opening 36 in the plug bolt 32. In the locked position of the bolt element 38 shown in FIG. 2, at least one section of the bolt element rests against a wall surface 40 of a recess 41 of the receiving opening 34. In addition, the locking device 30 includes an actuating element 42 in the form of an actuating lever for displacing the bolt element 38 from the locked position shown in FIG. 2 into a released position in which the bolt element 38 is accommodated within the lateral surface of the plug bolt 32.

As shown in FIG. 2, in the embodiment of the locking device 30 the support of the bolt element 38 is thus designed in such a way that the bolt element 38 comes to rest in a recess 41 in a wall of the receiving opening 34. When external forces act on the coupling elements, the bolt element 38 experiences no forces that would allow displacement of the bolt element 38. The locking device 30 may thus be effectively prevented from undesirably opening on its own. In the embodiment shown in FIG. 2, the bolt element 38 is displaced along an axis that is preferably parallel to an edge of the corresponding recess 41 in the counterpart.

In the embodiment shown, the wall surface 40 against which the bolt element 38 is supported in its locked position is not oriented in parallel to the longitudinal axis of the plug bolt 32. Instead, the wall surface 40 is oriented in the same direction as the through opening 36 in the plug bolt 32.

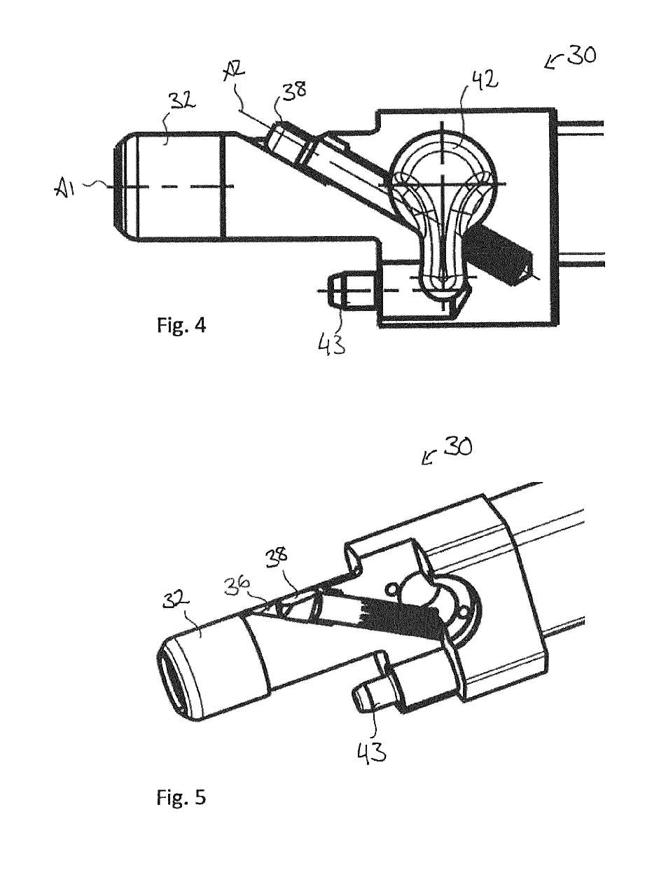

FIGS. 3 and 4 show detailed views of the locking mechanism from FIG. 2. As shown in FIGS. 3 and 4, an additional guide pin or torsion bolt 43 may be provided which is likewise insertable into a corresponding receptacle on the respective other module in order to prevent a relative rotation of the two coupled-together modules about a longitudinal axis of the plug bolt 32.

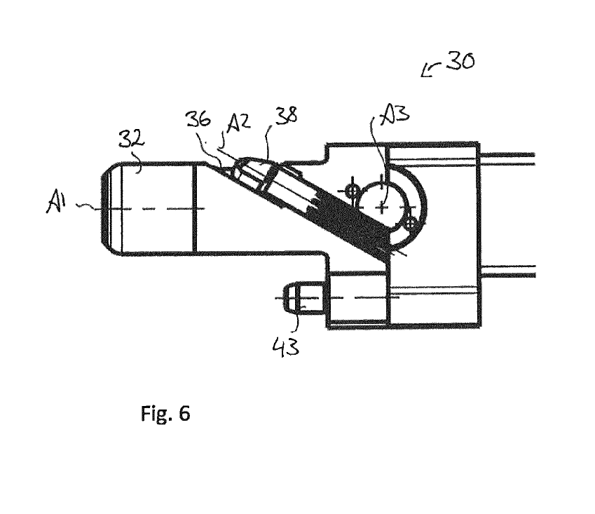

FIGS. 5 and 6 show detailed views of a locking device 30 according to another embodiment. The bolt element 38, in contrast to the first embodiment, is rotatable about an axis in order to achieve form-fit locking. Operation could then take place, for example, by means of a button which is pretensioned with a spring, and which in the neutral position of the button rotates the bolt element 38 into a first position in which a section of the bolt element 38 protrudes beyond the lateral surface of the plug bolt 32 and thus locks the plug bolt 32 in a correspondingly shaped receiving hole (not shown). When the button is actuated, the bolt element 38 is rotated into a second position, the bolt element 38 coming to rest within the lateral surface of the plug bolt 32, so that the plug bolt 32 may be inserted into the receiving hole on the respective other module to be coupled, or removed therefrom, unhindered.

Alternatively, a bolt element is contemplated that is made up of multiple elements, wherein, for example, only individual elements of this bolt element are swiveled about a defined axis.

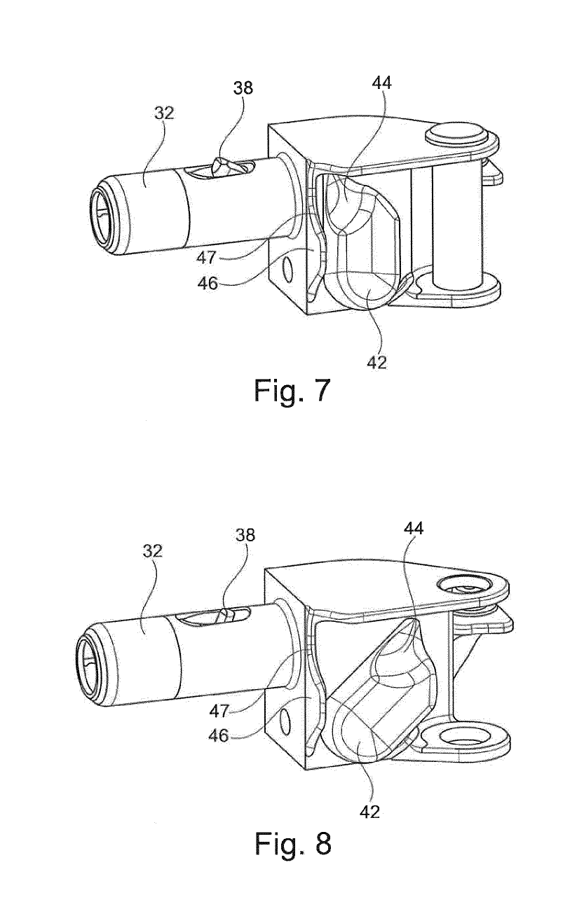

FIGS. 7 and 8 illustrate one embodiment of an actuating element in which the actuating lever 42 includes a recessed grip 44 with which, for example, a thumb or a finger of a user can engage in order to move the actuating lever from its first position shown in FIG. 7 into its second position shown in FIG. 8.

Alternatively, instead of such an actuating lever, an elongation of the bolt element 38 may be provided in such a way that a control element such as an eye or a hook, with which a user can move the bolt element 38 between a first locked position and a second released position, is provided on the end of the bolt element opposite from the blocking bolt section.

According to further embodiments, an extension, for example a cross bolt, on which a finger lever may then be mounted and by means of which the bolt element 38 can be moved, could also be provided on the bolt element 38. It would likewise be conceivable for the bolt element to be brought into both end positions via a cam disk, formed on a toggle, by rotating the toggle.

In the embodiment shown in FIGS. 7 and 8, the bolt element 38 may be controlled via gearing between the bolt element 38 and the actuating lever 42. A gearwheel segment that is preferably situated at right angles to the longitudinal axis of the bolt element 38 may be provided on the actuating lever 42, the gearwheel being engaged with a toothed rack on the bolt element 38. Alternatively, the actuating lever could be designed in such a way that it can accommodate a toothed segment that controls the bolt element 38, optionally via a flange, or the gearwheel or gearwheel segment could be mounted on the bolt element 38, and the toothed rack could be mounted on the actuating lever 42.

The locking device 30 shown in FIGS. 7 and 8 also has one or more deflector ribs 46 that protect the actuating lever 42, designed as a thumb lever, for example, from unintentional actuation, so that a user cannot release the lever by accidentally getting caught, and instead can actively and securely actuate the lever only through the recess 47 in the area of the deflector ribs 46.

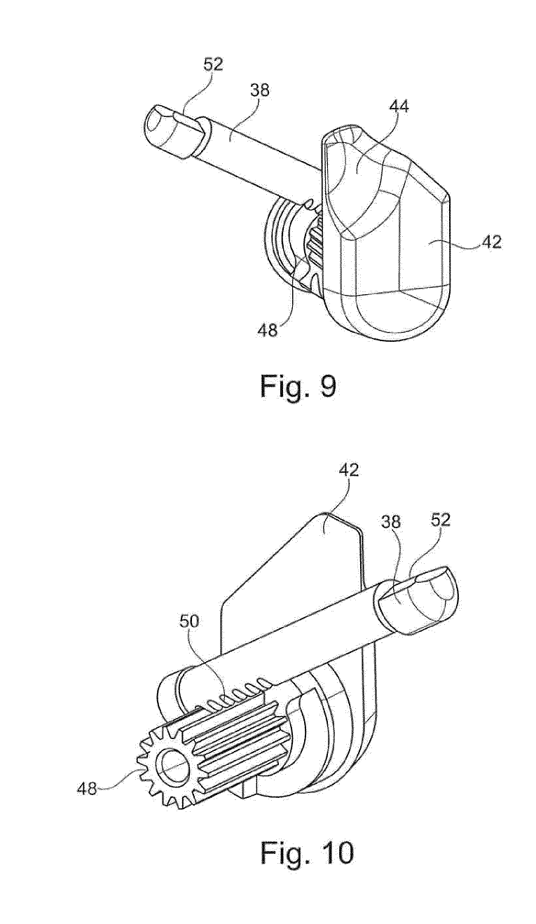

FIGS. 9 and 10 show the gearing of the actuating lever 42 and the bolt element 38, without the plug bolt 32. It is seen here that the gearwheel 48 is mounted on the actuating lever 42, and is engaged with a toothed rack section 50 on the bolt element 38. It is also apparent in FIGS. 9 and 10 that one end of the bolt element 38 has a flat side surface or contact surface 52, which in the locked state rests against a corresponding wall surface 40 of a recess in a receiving opening of the respective other module. Such a flat contact surface 52 is less sensitive to deformations in comparison to ball-shaped bodies.

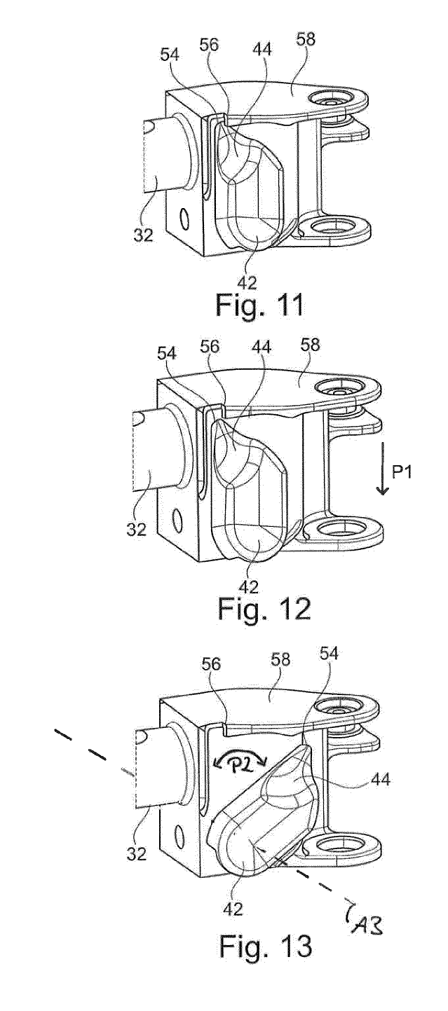

FIGS. 11 through 13 show one embodiment of the actuating lever as a detent lever that securely engages in one of its end positions, in the present case, in the locked position of the bolt element 38. The actuating lever 38 is thus protected from unintentional actuation, since a user must first release the actuating lever 38 before it can be moved into a released position.

As shown in FIG. 11, in the detent position a locking tab 54 of the actuating lever 42 rests against a contact surface 56 that is fixedly connected to the plug bolt 32. In the embodiment shown, the contact surface 56 is integrally formed with a base body 58 of the locking device 30. The base body 58 may be fastened to a module of an operating table. In the detent position, it is not possible for the actuating lever 38 to rotate about the axis A3, which is preferably orthogonal to the axis A1 of the plug bolt 32 and the axis A2 of the bolt element 38, and the bolt element 38 is thus securely fixed in its locked position.

For actuating the actuating lever 42 into a released position of the locking device 30, the user, as shown in FIG. 12, must initially press the actuating lever 42 at least by the magnitude of the height of the locking tab in the direction of the arrow P1, so that the locking tab 54 is moved past the contact surface 56. As shown in FIG. 13, the actuating lever 42 may then be rotated about an axis A3 in the direction of the arrow P2, and the bolt element 38 may move into its released position.

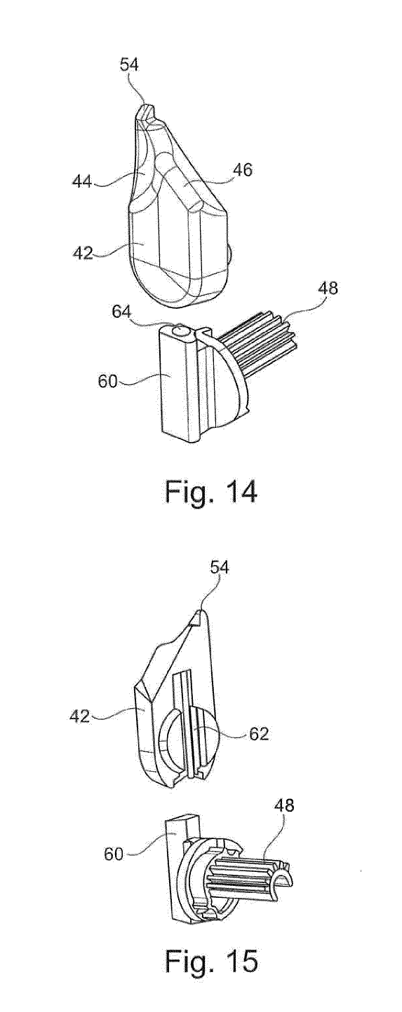

FIGS. 14 and 15 show one possible design of the actuating lever 42, shown in FIGS. 11 through 13, as a two-part lever element that includes a lever sleeve 60 and a lever sleeve support 62. The first lever element includes the locking tab 54 and the recessed grip 44, and is supported so as to be slidable with respect to the second lever element, which includes the gearwheel or gearwheel segment 48. A cylindrical spring may be provided in the borehole 64 of the lever sleeve 60 in order to pretension the actuating lever 42 into the detent position.

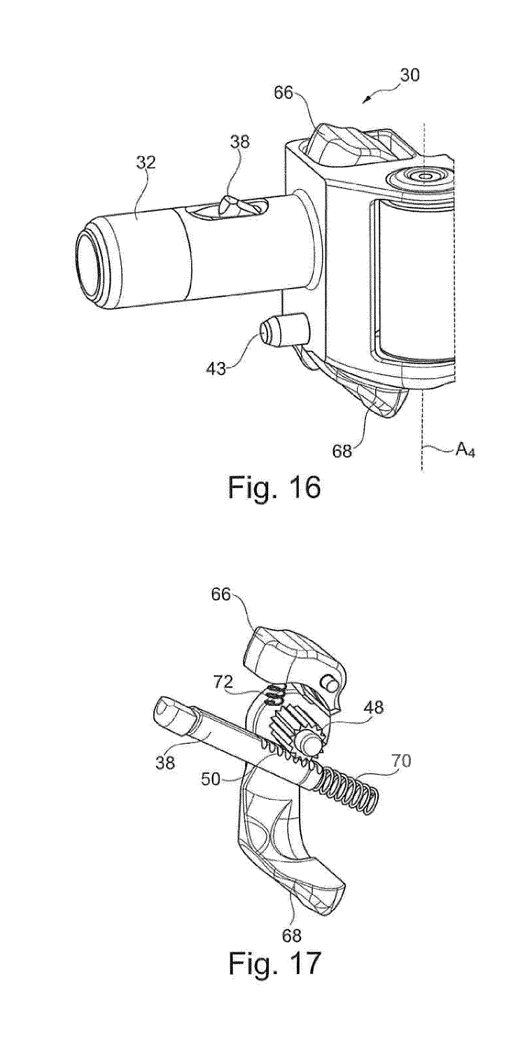

FIGS. 16 and 17 show another embodiment of the locking device 30, wherein a finger lever release at the bottom is provided with a toothed segment and an additional safety button 66 at the top. This embodiment provides a very space-saving approach, since, for example, an articulated joint with a swivel axis A4 may be provided in the immediate vicinity of the interface, as illustrated in FIG. 16. FIG. 17 shows an overview of the interlocking components, without the plug bolt 32.

Only when the release button 66 at the top is pressed, preferably with the thumb, can the finger lever 68 at the bottom be rotated about its swivel axis A3, preferably with the index finger. When the finger lever 68 is released, it is rotated via the toothed segment 48 into a first lever position, for example by a spring 70 that pretensions the bolt element 38 into its locked position. As soon as this is achieved, the release button is pressed into its end position, for example by a cylindrical spring 72 below the button cap, and automatically blocks the finger lever 68. Thus, in this embodiment, releasing the bolt element 38 is possible only when both the release button 66 and the finger lever 68 are pressed. Releasing the finger lever 68 results in an automatic movement of the bolt element 38 into its locked position under the action of the spring 70. Due to the rigid coupling of the bolt element 38 and the finger lever 68, the user can see and feel which position the bolt element 38 is in at that moment, and whether the bolt element 38 is securely locked in its locked position. Snapping in the bolt element 38 and the finger lever 68 in the locked position also provides the user with acoustic feedback as to whether the bolt element 38 is securely engaged.

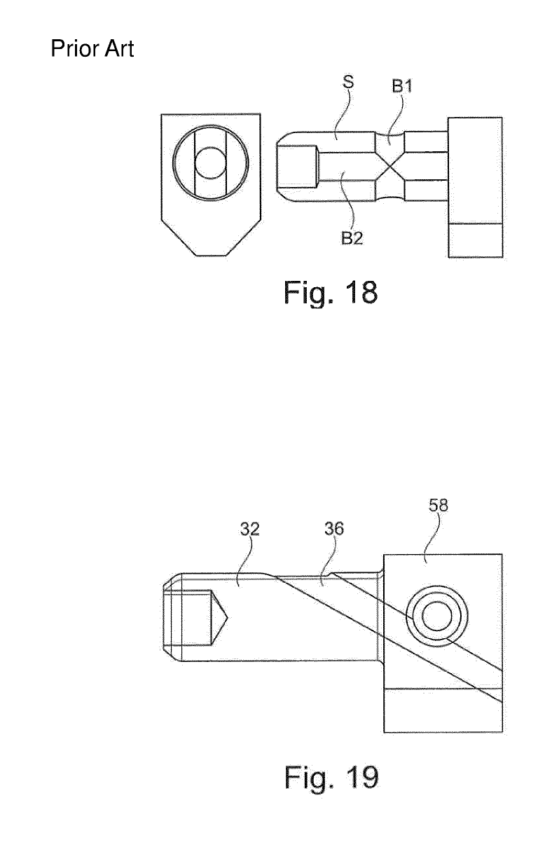

FIGS. 18 and 19 illustrate a further advantage of the locking device 30 according to the embodiments shown in FIGS. 2 through 17. In a conventional plug bolt S, in which, for example, a ball is used as a bolt element, two boreholes B1 and B2 are generally provided, one along the longitudinal axis of the plug bolt S and one perpendicular thereto, as shown in FIG. 18. The detent ball may thus be displaced perpendicularly with respect to the longitudinal axis of the plug bolt S, and an actuating element is moved parallel to the longitudinal axis of the plug bolt S.

All of the above-described embodiments of the actuating lever, with or without a separate release button, allow the operator to hold the module to be decoupled, and with one or two fingers to actuate the control elements for unlocking without having to grip or release the module. If only passive safety measures, such as deflector ribs 46, are provided on the actuating lever 42, the coupling is particularly simple, since the user only has to insert the module to be coupled into the desired interface. If a separate release button 66 is provided, during the coupling it is necessary only to press this release button, since the finger lever 68 is automatically rotated into its locked position.

Unintentional opening of the locking device 30 may be reliably prevented in all of the above-described embodiments of the actuating lever, since the lever may be concealed and/or limited in movement by means of a release button. At the same time, all control elements may be situated in the field of vision of the user, so that there are no concealed buttons, and the operation of the locking device is therefore easily understandable by the user.

FIG. 19 shows the plug bolt 32 with the through opening 36 situated at an acute angle relative to the longitudinal axis of the plug bolt 32. It is apparent that the through opening 36 weakens the plug bolt 32 significantly less than the two boreholes shown in FIG. 18. In particular for modules of patient support surfaces that must support heavy loads such as the weight of a patient together with other surgical instruments or equipment, it is advantageous when the plug bolt 32 has the greatest possible load-bearing capacity and is not weakened by unnecessary boreholes.

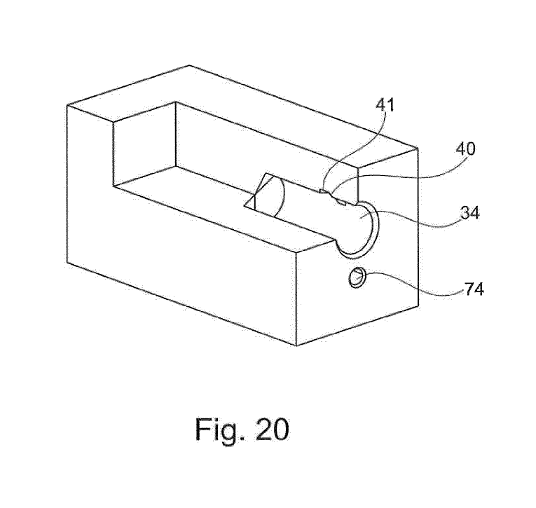

FIG. 20 shows a partially cutaway view of a receiving opening 34 of a female interface for the coupling with the above-described locking device 30. As explained above in conjunction with FIG. 2, a recess 41 is used to accommodate the bolt element 38 in its locked position, in which it protrudes beyond the lateral surface of the plug bolt 32 that is inserted into the receiving opening 34. The contact surface 52 of the bolt element 38 is then in form-fit engagement with the beveled wall surface 40 of the recess 41. Particularly secure locking of the plug bolt 32 in the receiving opening 34 may thus be achieved, since forces that act on the locking device 30 in the direction of the longitudinal axis A1 of the plug bolt 32 do not result in the bolt element 38 being moved out of its locked position.

An opening 74 is used to accommodate the guide pin or torsion bolt 43 of the locking device 30, which prevents rotation of the locking device 30 about the longitudinal axis A1 of the plug bolt 32 and ensures a defined mutual orientation of the two modules to be coupled.

In this way, the locking device 30 according to the disclosure achieves a high load-bearing capacity up to the point of shearing off of the bolt elements or deformation of the plug pin 32, and is economical to manufacture since little machining of the plug pin 32 is necessary.

Thus, in summary, effective securing mechanisms are provided for the locking device described above, so that the interface can be operated only in a targeted and deliberate manner.

In addition, for the locking device according to the disclosure, to solve the problem of the high surface pressures in the area of the contact surfaces of the bolt element, the contact surfaces are enlarged and adapted to the given contour of the groove in the female interface.

To ensure compatibility of the locking device with existing female adapters on modules of operating tables, beds, couches, and the like, the control elements for actuating the interface are preferably mounted only on the module side, since a change in the existing pin interface holder is not desired. For example, any of the exchangeable modules 14, 16, 18, 20 could be equipped with any of the locking devices 30 disclosed herein.

In a further aspect, the operation of the actuating elements may be designed in such a way that it is possible to actuate the control element at the same time that the module is being held, so that, without changing the grip position, the control element can subsequently decouple the module from the interface and move it in space relative to the base support surface. The safety of a patient lying on the operating table may thus be ensured, even when individual modules are being exchanged.

Embodiments can includes a patient support surface module 14, 16, 18, 20 for supporting a patient body part, having a locking device (30) that includes the following:
a plug bolt 32;
a bolt element 38 that is movably accommodated in a through opening 36 in the plug bolt 32, wherein a longitudinal axis of the through opening 36 extends at an acute angle relative to a longitudinal axis of the plug bolt 32; and
an actuating element 42; 68 by means of which the bolt element (38) is movable between a released position and a locked position.

A bolt element 38 may be linearly displaceably situated in the through opening 36. The bolt element 38 includes a toothed rack 50 in some embodiments, and the actuating element 42; 68 can then include a gearwheel 48 or a gearwheel segment 48 in order to bring about a displacement of the bolt element 38 via rotation of the actuating element 42; 68.

The the bolt element 38 can be rotatably situated in the through opening 36, or both displaceably and rotatably situated in the through opening.

The actuating element 42 can have a finger lever or thumb lever, optionally having a recessed grip 44 for a finger or thumb of a user.

The locking device can include a base body 58 having at least one deflector rib 46 that prevents a user from being caught on the actuating element 42; 68.

The actuating element may have a release button 66, so that the actuating element is movable only after the actuation, or when the release button 66 is simultaneously actuated.

In some applications the actuating element 42 is movable from a first position, in which a movement of the bolt element 38 is blocked, into a second position, and wherein the actuating element is movable from the second position into a third position in order to move the bolt element 38 from its locked position into its released position. An actuating element 42 optionally includes a locking tab 54 which in the first position rests against a contact surface 56 of the locking device 30, and wherein the movement into the second position includes a displacement of the locking tab 54 relative to the contact surface 56.

This disclosure further contemplates a plug pin interface for connecting two patient support surface modules 14, 16, 18, 20, including a male patient support surface module, and a female patient support surface module having a receiving opening 34 for accommodating the plug bolt 32 of the locking device 30, and having a locking recess 41 in the receiving opening 34 for accommodating the bolt element 38 of the locking device 30. In some applications at least one wall surface 40 of the locking recess 41 extends essentially parallel to a longitudinal axis of the through opening 36 in the plug bolt 32, so that a side-face 52 of the bolt element 38 in the locked position rests against the wall surface 40. In some applications at least one area of the wall surface 40 of the locking recess 41 that may come into contact with an area of the bolt element has a cylindrical design, and conical design, a dome-shaped design, or a spherical design. In some applications at least one area of the wall surface 40 of the locking recess 41 is essentially congruent with the surface of the section of the bolt element that comes into contact.

This disclosure includes patient support surface modules 14,16, 18, 20 having locking devices 30. It also includes medical table arrangements having torso support surfaces 10 and/or bases and columns, one or more patient support surface modules 14,16, 18, 20 engaged or engageable in female receptacles 34 of of medical table, and methods of using, assembling, disassembling, and exchanging same.

### LIST OF REFERENCE NUMERALS

10 torso support surface

12 patient support surface

14, 16, 18, 20 modules

22 plug pin interface

30 locking device

32 plug bolt

34 receiving opening

36 through opening in the plug bolt

38 bolt element

40 wall surface of a recess

41 recess of the receiving opening

42 actuating element

43 guide pin (torsion bolt)

44 recessed grip

46 deflector ribs

47 recess of the deflector ribs

48 gearwheel/gearwheel segment/toothed/partially toothed shaft

50 toothed rack section

52 flat contact surface

54 locking tab

56 contact surface for actuating element 42

58 base body

60 lever sleeve

62 lever sleeve support

64 borehole

66 safety button/release button

68 finger lever

70 spring (spring element 1)

72 cylindrical spring (spring element 2)

P1 directional arrow: movement direction 1

P2 directional arrow: movement direction 2

A1 central (directional) axis of the plug bolt 32

A2 central (directional) axis of the bolt element 38/receiving opening 36

A3 central axis of the toothed shaft/swivel axis

A4 swivel axis of an articulated joint

B1 borehole

B2 borehole

S plug bolt

1. A patient support surface module for supporting a patient body part, the patient support surface module comprising a locking device that includes the following:
a plug bolt;
a bolt element that is movably accommodated in a through opening in the plug bolt, wherein a longitudinal axis of the through opening extends at an acute angle relative to a longitudinal axis of the plug bolt; and
an actuating element by means of which the bolt element is movable between a released position and a locked position.

2. The patient support surface module according to claim 1, wherein the bolt element is linearly displaceably situated in the through opening.

3. The patient support surface module according to claim 2, wherein the bolt element includes a toothed rack, and the actuating element includes a gearwheel or a gearwheel segment in order to bring about a displacement of the bolt element via rotation of the actuating element.

4. The patient support surface module according to claim 1, wherein the bolt element is rotatably situated in the through opening.

5. The patient support surface module according to claim 1, wherein the bolt element is displaceably and rotatably situated in the through opening.

6. The patient support surface module according to claim 1, wherein the actuating element has a finger lever or thumb lever having a recessed grip for a finger or thumb of a user.

7. The patient support surface module according to claim 6, wherein the locking device includes a base body having at least one deflector rib to prevent a user from being caught on the actuating element.

8. The patient support surface module according to claim 1, wherein the actuating element has a release button, so that the actuating element is movable only after the actuation, or when the release button is simultaneously actuated.

9. The patient support surface module according to claim 1, wherein the actuating element is movable from a first position, in which a movement of the bolt element is blocked, into a second position, and wherein the actuating element is movable from the second position into a third position in order to move the bolt element from its locked position into its released position.

10. The patient support surface module according to claim 9, wherein the actuating element includes a locking tab which in the first position rests against a contact surface of the locking device, and wherein the movement into the second position includes a displacement of the locking tab relative to the contact surface.

11. A plug pin interface for connecting two patient support surface modules, comprising:
a patient support surface module according to claim 1, and
a female patient support surface module having a receiving opening for accommodating the plug bolt of the locking device, and having a locking recess in the receiving opening shaped for accommodating the bolt element of the locking device.

12. The plug pin interface according to claim 11:
wherein at least one wall surface of the locking recess extends essentially parallel to a longitudinal axis of the through opening in the plug bolt when the plug bolt of the locking device is engaged in the receiving opening of the female patient support surface module, so that a side face of the bolt element in the locked position rests against the wall surface.

13. The plug pin interface according to claim 12, wherein at least one area of the wall surface of the locking recess that may come into contact with an area of the bolt element has a cylindrical shape.

14. The plug pin interface according to claim 12, wherein at least one area of the wall surface of the locking recess that may come into contact with an area of the bolt element has a conical shape.

15. The plug pin interface according to claim 12, wherein at least one area of the wall surface of the locking recess that may come into contact with an area of the bolt element has a dome-shaped shape.

16. The plug pin interface according to claim 12 wherein at least one area of the wall surface of the locking recess that may come into contact with an area of the bolt element has a semi-spherical shape.

17. The plug pin interface according to claim 12 wherein at least one area of the wall surface of the locking recess is essentially congruent with the surface of the section of the bolt element that comes into contact.

18. A patient support surface module for supporting a patient body part, the patient support surface module comprising a locking device that includes the following:
a plug bolt;
a bolt element that is movably accommodated in a through opening in the plug bolt, wherein a longitudinal axis of the through opening extends at an acute angle relative to a longitudinal axis of the plug bolt; and
an actuating element by means of which the bolt element is movable between a released position and a locked position;
wherein the actuating element has a finger lever or thumb lever for a finger or thumb of a user; and
wherein the locking device includes a base body having at least one deflector rib to prevent a user from being caught on the actuating element.

19. A patient support surface module for supporting a patient body part, the patient support surface module comprising a locking device that includes the following:
a plug bolt;
a bolt element that is movably accommodated in a through opening in the plug bolt, wherein a longitudinal axis of the through opening extends at an acute angle relative to a longitudinal axis of the plug bolt; and
an actuating element by means of which the bolt element is movable between a released position and a locked position;
wherein the actuating element has a release button, so that the actuating element is movable only after the actuation, or when the release button is simultaneously actuated.

20. The patient support surface module according to claim 19, wherein the bolt element includes a toothed rack, and the actuating element includes a gearwheel or a gearwheel segment configured to displace the bolt element via rotation of the actuating element.
